(19) United States
(12) Patent Application Publication
(10) Pub. No.: US 2014/0246866 A1
(43) Pub. Date: Sep. 4, 2014

(54) MICRO-MOTION GENERATOR APPARATUS

(71) Applicant: Scott E. Gossler, San Diego, CA (US)

(72) Inventor: Scott E. Gossler, San Diego, CA (US)

(21) Appl. No.: 14/126,318

(22) PCT Filed: Jul. 9, 2012
(86) PCT No.: PCT/US12/45966

§ 371 Date: Mar. 14, 2014

Related U.S. Application Data
(60) Provisional application No. 61/506,088, filed on Jul. 9, 2011.

(51) Int. Cl. H02K 7/18; H02K 7/065

(52) U.S. Cl. CPC H02K 7/1876; H02K 7/065
USPC 290/1 R; 310/10; 310/30

(57) ABSTRACT

A micro-motion generator or apparatus attached to an article such as an article of clothing generates an electric current to power a load device of the apparatus, for example an LED on the article of clothing in response to movements of the person wearing the article of clothing. The component parts of the apparatus are constructed with dimensions that enable the apparatus to be made a part of an object.

This patent application claims the benefit of the filing date of provisional patent application No. 61/506,088, filed on Jul. 9, 2011.

### BACKGROUND OF THE INVENTION

1. Field of the Invention

The present invention pertains to a micro-motion generator apparatus that can be attached to an object that experiences frequent movements. For example, a person or animal, a vehicle such as a car or boat, a recreational device such as a ball or racket, etc. The apparatus will generate an electric current to power a load device, for example an LED on the object in response to the movements of the object.

2. Description of the Related Art

Articles of clothing, for example shoes have been modified with electrical devices that flash or light up in response to movements of the shoe by the person wearing the shoe, or by impact of a shoe sole on a surface during walking or running. Lights have been provided on the shoe as decorations for the shoe and/or as a safety feature that makes the wearer of the shoe more visible. Electronic devices of this type are often powered by a small battery also carried by the article of clothing. The battery could be replaceable, or rechargeable. Still other electronic devices of this type include small electric generators that generate an electric current to power the light or other load device on the article of clothing in response to the movement of the article of clothing.

Prior art electronic devices used on articles of clothing have been disadvantaged in that their constructions significantly increase the costs involved in manufacturing the article of clothing, which in turn results in an increased cost to the consumer. Additionally, the constructions of some electrical devices employed on articles such as clothing are complex and include many different components. Each component presents a possibility of where the electrical device could fail, resulting in the dissatisfaction of the purchaser.

What is needed to overcome the shortcomings of prior art electrical devices employed on objects that experience frequent movements, such as an article of clothing is an apparatus that has a simplified construction with few component parts that operate together in a very simple way to produce an electric current to power an electric load of the apparatus, thereby reducing the manufacturing costs of the apparatus and reducing the possibility of the apparatus failing.

### SUMMARY

The micro-motion generator apparatus of the present invention overcomes the above described disadvantages associated with prior art electronic devices employed on objects that move, such as clothing. The generator apparatus of the invention produces an electric current that powers a load device. The apparatus has a small number of component parts that are simply assembled together and function together to produce an electric current to power the load device on the object on which the apparatus is used.

The component parts of the apparatus are constructed with dimensions that enable the apparatus to be made a part of an object, for example an article of clothing such as a shoe, an armband, a headband, a shirt, etc. The component parts are also constructed of materials having sufficient structural strength for their intended functions while limiting the weight of the component parts so that the apparatus on the particular object does not interfere with the movement of the object. Although the apparatus is described herein as being used on an article of clothing, this should not be interpreted as limiting. The apparatus may be used on any object that experiences frequent movements.

The micro-motion generator apparatus is centered around a micro generator assembly. The generator assembly includes a cylindrical sealed chamber having opposite first and second ends. Although a cylindrical chamber is preferred, the chamber can have any configuration that allows for a coil of wire being wrapped around the chamber as will be described. A spherical permanent magnet is contained in the chamber interior. The magnet diameter dimension is smaller than the chamber interior diameter dimension so that the magnet is free to move linearly through the length of the chamber between the chamber first and second ends, and in rotation around an interior surface of the chamber. Although a spherical magnet is preferred, the magnet can have other configurations so long as the dimensions of the magnet allow it to freely move around the interior of the chamber. A length of wire is wrapped in a coil around the outside of the chamber. The linear reciprocating movements of the magnet through the chamber interior and the rotational movements of the magnet around the interior surface of the chamber in response to movements of the chamber induce an electric current in the coil. The opposite ends of the coil are connected to an electric load device, for example and LED.

The generator assembly and the load device are positioned on an object that experiences frequent movements, for example a person or animal, a vehicle such as a car or boat, a recreational device such as a ball, racket or toy, etc. As an example only, the apparatus is described as used on an article of clothing. The generator assembly is positioned on the article of clothing where the generator assembly will be subjected to movements of the person wearing the article of clothing. For example, the generator assembly could be positioned in a shoe sole. Walking or running strides of a person wearing the shoe result in movements of the generator assembly. The movements of the generator assembly result in reciprocating movements of the magnet in the chamber and rotation of the magnet around the interior surface of the chamber. The movements of the magnet induce a current in the coil that powers the load device on the article of clothing.

In a further embodiment of the micro-motion generator apparatus, the apparatus is also centered around a micro generator assembly that includes a cylindrical sealed chamber having opposite first and second ends. A cylindrical permanent magnet is contained in the chamber. The magnet engages in a sliding, sealing engagement with an interior surface of the chamber. The sliding engagement enables the magnet to freely linearly reciprocate through the interior of the chamber between the chamber first and second ends. A length of wire is wrapped in a coil around the outside of the chamber. The reciprocating movement of the magnet through the chamber induces an electric current in the coil. The opposite ends of the wire coil are connected to an electrical load device, for example an LED.

A first fluid bladder communicates with the first end of the chamber. A second fluid bladder communicates with the second end of the chamber. Compressing the first fluid bladder causes fluid to move from the bladder and into the chamber at the chamber first end, where the fluid forces the magnet to move through the chamber to the chamber second end. This movement of the magnet in turn causes fluid to be pushed from the chamber second end and into the second bladder. Compressing the second bladder causes fluid to move from the second bladder and into the chamber at the chamber second end. Fluid entering the chamber at the chamber second end pushes the magnet through the chamber to the chamber first end. This movement of the magnet causes fluid to exit from the chamber first end and flow into the first bladder.

The generator assembly, the load device, the first bladder and the second bladder are positioned on an object that experiences frequent movements, such as an article of clothing. The apparatus is positioned on the article where the first and second bladders will be alternately subjected to forces resulting from the movements of a person wearing the article. For example, the generator assembly, the first bladder and the second bladder could be positioned in a shoe sole with the first bladder positioned toward the heel of the shoe and the second bladder positioned toward the toe of the shoe. The load device would be positioned on the exterior of the shoe. Walking or running strides of a person wearing the shoe would result in the first bladder being compressed by the person's heel on the initial foot fall of the stride, and then subsequently the second bladder being compressed by the ball of the person's foot with the heel of the person's foot being raised from the first bladder as the person completes the foot stride. These repeated movements of the person's foot would cause the magnet to reciprocate in the chamber and induce a current in the coil that powers the load device.

As described above, the micro-motion generator apparatus provides an inexpensively manufactured and efficiently assembled and operated generator assembly that could be provided on an object that experiences frequent movements, to power a load device on the object in response to movements of the object.

### BRIEF DESCRIPTION OF THE DRAWINGS

Further objects and features of the present invention are set forth in the following drawing figures and the following detailed description.

FIG. 1 is a perspective view of a first embodiment of the micro-motion generator apparatus of the invention.

FIG. 2 is a top plan view of the apparatus of FIG. 1.

FIG. 3 is a side sectioned view of the apparatus of FIG. 1.

FIG. 4 is a perspective view of the disassembled component parts of a further embodiment of the apparatus of the invention.

FIG. 5 is a perspective view of the generator assembly of FIG. 4 removed from the apparatus of the invention.

FIGS. 6, 7 and 8 illustrate the assembly of the component parts of the further embodiment of the apparatus and their positioning in an object such as a shoe sole.

FIG. 9 is a side sectioned view of a representation of the further embodiment of the apparatus illustrating the operation of the apparatus.

FIG. 10 is a side sectioned view similar to that of FIG. 9 and further illustrating the operation of the apparatus.

### DETAILED DESCRIPTION

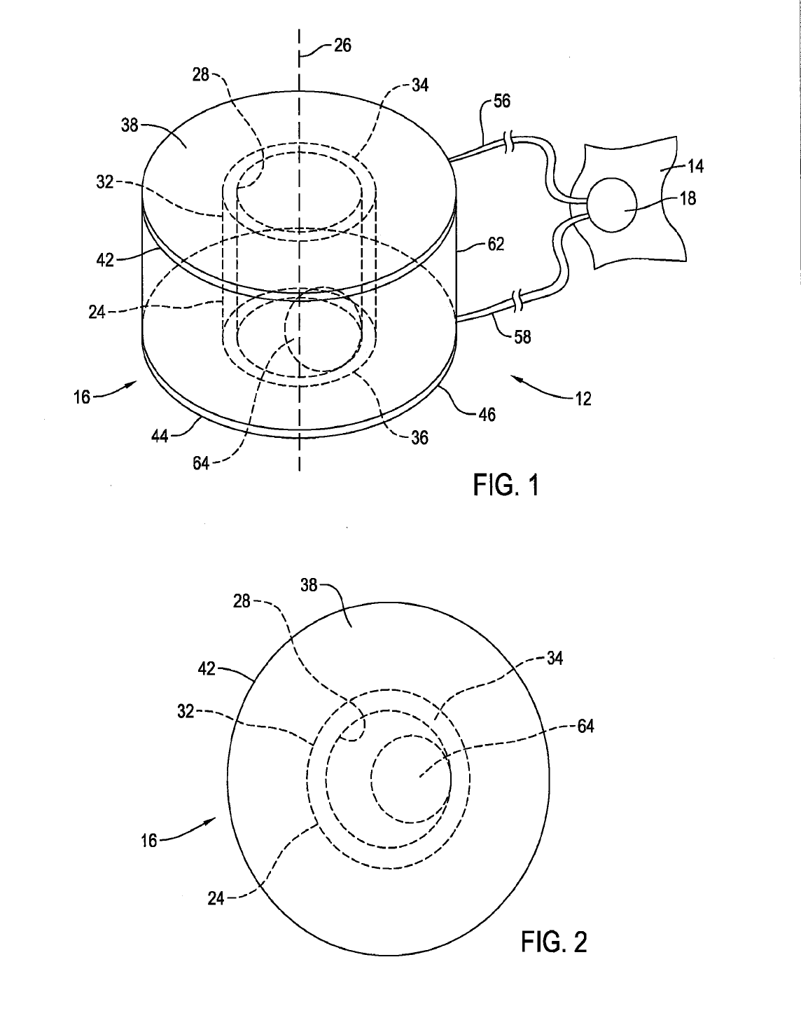

FIG. 1 is a perspective view of the micro-motion generator apparatus 12 employed on an object 14. The apparatus 12 could be employed on most any object that experiences frequent movements or vibrations. For example, a person or animal, a vehicle such as a car or boat. The object 14 could be an article of clothing such as a shoe, shirt, headband, etc. Additionally, the object 14 could be a recreational device such as a ball, a manually thrown flying disc, a child's toy or other similar object that experiences frequent movements in use of the object. The apparatus 12 is basically comprised of a generator assembly 16 and a load device 18, for example an LED that are attached to the object 14.

These basic component parts are constructed with dimensions that would enable the apparatus of the invention to be made a part of an object or used on an object such as those discussed above. Additionally, the component parts are constructed of materials having sufficient structural strength for their intended functions while limiting the weight of the component parts so that the apparatus on the particular object does not interfere with the movements of the object. Although the apparatus is described herein as being used on an article of clothing, this should not be interpreted as limiting. The apparatus may be used on any object that experiences frequent movements or vibrations. Although an LED is described as the load device 18, other types of devices could be used in the apparatus such as an output power plug connectable to a personal electronic device, or some other electric load device.

The generator assembly 16 includes a sealed chamber having a cylindrical sidewall 24 with a center axis 26 that defines mutually perpendicular axial and radial directions relative to the apparatus. Although a cylindrical chamber is preferred, the chamber can have any configuration that allows for coils of wire to be wrapped around the chamber as will be described. The sidewall 24 has a smooth cylindrical interior surface 28 surrounding an interior volume of the chamber and a radially opposite cylindrical exterior surface 32. The interior 28 and exterior 32 surfaces extend axially between opposite first 34 and second 36 end edges of the sidewall.

A first end wall formed as a flat circular disc 38 is secured to the sidewall first end edge 34. The disc 38 seals closed the chamber sidewall 24 at the first end edge. The disc 38 is coaxial with the sidewall 24 and extends radially outwardly from the sidewall center axis 26 to an outer circular edge 42 of the disc.

A second end wall formed as a flat circular disc 44 is secured to the sidewall second end edge 36. The second disc 44 seals closed the chamber interior volume at the second end edge 36 of the sidewall. The second disc 44 is substantially the same size as the first disc 38 and is coaxial with the first disc. The second disc 44 extends radially outwardly from the sidewall center axis 26 to an outer circular edge 46 of the second disc. Although the first and second circular discs are described, other configurations of end walls could be secured to the axially opposite end edges of the sidewall.

At least one length of wire having opposite first 56 and second 58 ends is wrapped in coils 62 around the exterior surface 32 of the chamber sidewall 24. In the illustrative embodiment, the wire is 40 to 43 gauge and is wrapped in 1,000 to 8,000 coils 62 around the chamber sidewall 24. The wire coils 62 extend between the first 38 and second 42 circular discs. Other numbers of coils and gauge of wire could be used based on the intended functioning of the apparatus. The first 56 and second 58 ends of the wire length extend radially outwardly from the coils 62.

A magnet 64 is received in the chamber sidewall 24. The magnet 64 is a permanent magnet having a spherical shaped exterior surface. Although a spherical magnet is preferred, the magnet could have other configurations so long as the magnet is dimensioned to freely move around and through the interior volume of the chamber. As seen in FIGS. 1-3, the magnet 64 has a diameter dimension that is smaller than the interior diameter dimension of the chamber sidewall 24. This enables the magnet 64 to move freely in axial reciprocating movements through the interior of the chamber sidewall 24 between the first 38 and second 44 discs, and enables the magnet to move in rotation around the interior surface 28 of the chamber sidewall 24 between the first 38 and second 44 discs. The magnet 64 could have half of its spherical shape with a positive polarity and half of its spherical shape with a negative polarity. Alternatively, the spherical shape of the magnet could be divided in quarters or other equivalent portions with half of the portions having a positive polarity and half of the portions having a negative polarity. There are no other mechanical component parts of the apparatus 12 in the interior of the chamber sidewall 24 between the first disc 38 and the second disc 44. This enables the magnet 64 to move in linear reciprocating movements through the interior of the chamber sidewall 24 and in rotational movements around the interior of the chamber sidewall 24. As the magnet 64 moves in the chamber sidewall 24, the movement of the magnet induces an electric current in the wire coils 62 surrounding the chamber sidewall 24.

The electric load device 18 is electrically connected between the first 56 and second 58 ends of the length of wire as represented in FIG. 1. As stated earlier, the load device 18 could be a light such as an LED, an electric coupling that is connectable to a separate personal electronic device such as a radio or recorded music player, or some other type of device. The current induced in the wire coils 62 in response to the movements of the magnet 64 in the interior volume of the chamber sidewall 24 powers the operation of the load device 18.

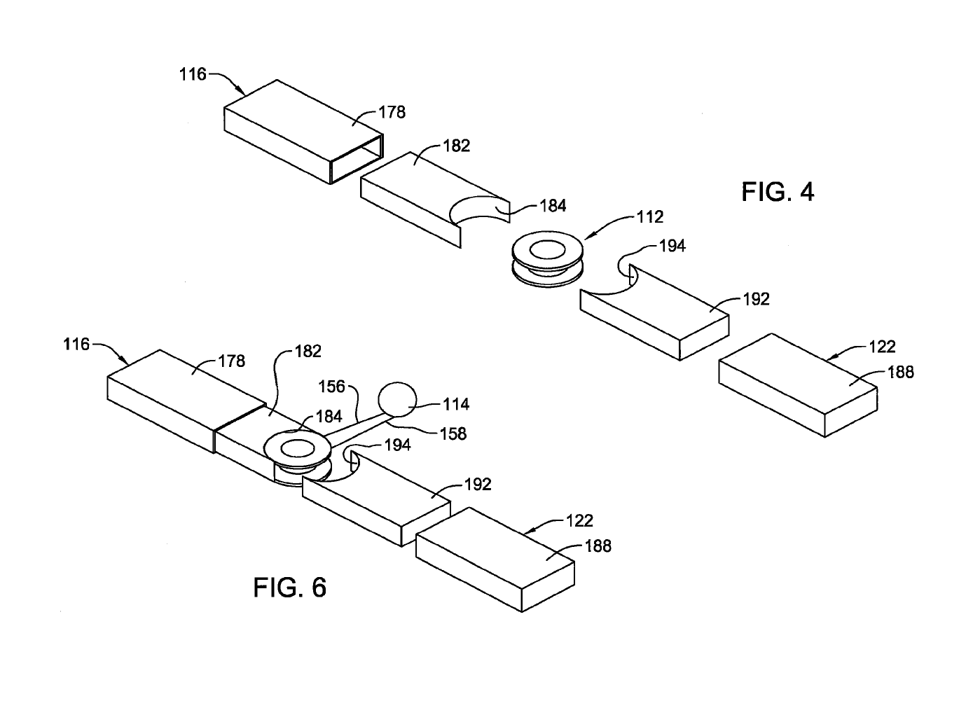

FIGS. 4-10 show a further embodiment of the micro-motion generator apparatus of the invention. FIG. 4 is an exploded view of several of the component parts of the apparatus. These basic component parts include a generator assembly 112, a load device 114, for example an LED, a first fluid tight bladder 116 containing an open cell foam core and a second fluid tight bladder 122 containing an open cell foam core. As in the previous embodiments, these basic component parts are constructed with dimensions that would enable the apparatus of the invention to be made a part of an object or used on an object such as those discussed earlier. Additionally, the component parts are constructed of materials having sufficient structural strength for their intended functions while limiting the weight of the component parts so that the apparatus on the particular object does not interfere with the movements of the object. Although an LED is described as the load device 114, other types of devices could be used in the apparatus such as an output power plug connectable to a personal electronic device, or some other electronic load device.

FIG. 5 is a perspective view of the generator assembly 112 removed from the apparatus. The generator assembly 112 includes a sealed, fluid tight chamber having a cylindrical sidewall 124 with a center axis 126 that defines mutually perpendicular axial and radial directions relative to the apparatus. The sidewall 124 has a smooth cylindrical interior surface 128 surrounding an interior volume of the chamber and a radially opposite cylindrical exterior surface 132. The interior 128 and exterior 132 surfaces extend axially between opposite first 134 and second 136 end edges of the sidewall 124.

A first, flat annular flange 138 projects radially outwardly from the sidewall first end edge 134 to a circular outer edge 142 of the flange. A radial groove 144 is formed in the axially outer surface of the flange 138. The groove 144 extends from the first end edge 134 of the fluid chamber sidewall 124 to the outer edge of the flange. The groove 144 forms a fluid flow path from the interior volume of the fluid chamber sidewall 124 across the flange 138 to the flange outer edge 142.

A second, flat annular flange 148 projects radially outwardly from the sidewall second end edge 136 to a circular outer edge 152 of the second flange. A radial groove 154 is formed in the axially outer surface of the second flange 148. The groove 154 extends from the second end edge 136 of the fluid chamber sidewall 124 to the outer edge 152 of the flange. The groove 154 forms a fluid flow path from the interior volume of the fluid chamber sidewall 124 across the flange 148 to the flange outer edge 152.

At least one length of wire having opposite first 156 and second 158 ends is wrapped in a coil 162 around the exterior surface 132 of the fluid chamber sidewall 124. The wire coil 162 extends between the first 138 and second 148 annular flanges. The first 156 and second 158 ends of the wire length extend radially outwardly from the coil 162 with the wire first end 156 adjacent the first annular flange 138 and the wire second end 158 adjacent the second annular flange 148. The ends of the wire can exit the coil as needed for the application. The above describes a preferred mode.

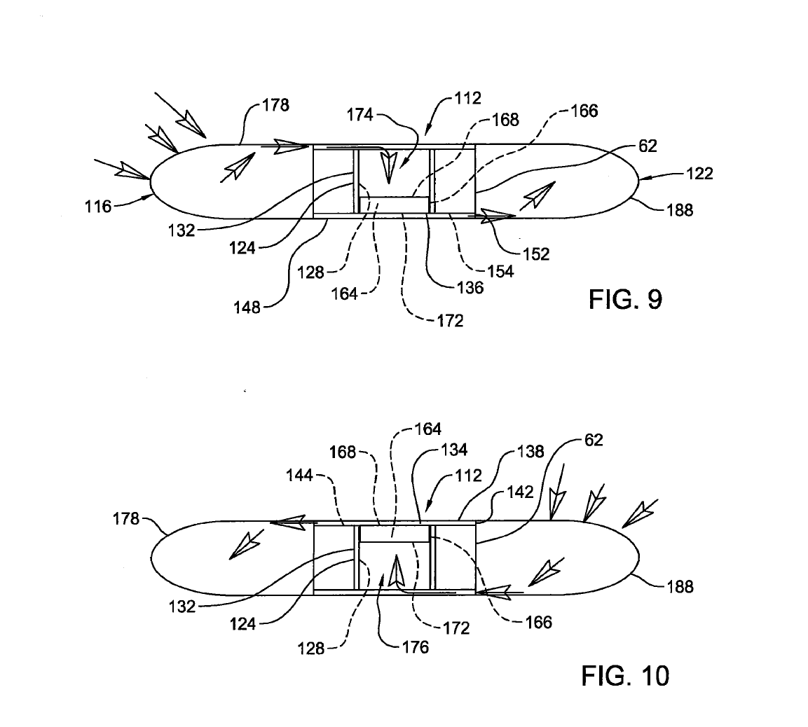

A magnet 164 is received in the fluid chamber sidewall 124. The magnet can also be seen in FIGS. 9 and 10. The magnet 164 is a permanent magnet having a cylindrical side surface 166, a first circular end surface 168 and an axially opposite second circular end surface 172. The magnet 164 divides the interior volume of the chamber 124 into a first portion of the interior volume 174 between the magnet first end surface 168 and the chamber sidewalk first end edge 134 and a second portion of the magnet interior volume 176 between the magnet second end surface 172 and the chamber sidewall second end edge 136. The magnet cylindrical side surface 166 is dimensioned to engage in a sealing, sliding engagement along the cylindrical interior surface 128 of the fluid chamber sidewall 124. There are no other mechanical component parts of the apparatus in the chamber interior volume between the first 134 and second 136 end edges of the sidewall or outside the chamber that would interfere with the free sliding movement of the magnet through the chamber cylindrical sidewall 124. This enables the magnet 164 to move in linear reciprocating movements through the fluid chamber between a first position of the magnet where the magnet first circular end surface 168 is in substantially the same plane as the first annular flange 138 of the fluid chamber, and a second position of the magnet 164 where the magnet second circular end surface 172 is in substantially the same plane as the second annular flange 148 of the fluid chamber. As the magnet 164 moves in linear reciprocating movements through the fluid chamber, the reciprocating magnet induces an electric current in the wire coil 162 surrounding the fluid chamber sidewall exterior surface 132.

The electric load device 114 is electrically connected between the first 156 and second 158 ends of the length of wire as represented in FIG. 5. As stated earlier, the load device 114 could be a light such as an LED, an electric coupling that is connectable to a separate personal electronic device such as a radio or recorded music player, or some other type of device. The current induced in the wire coil 162 in response to the reciprocating movements of the magnet 164 through the fluid chamber sidewall 124 powers the operation of the load device 114.

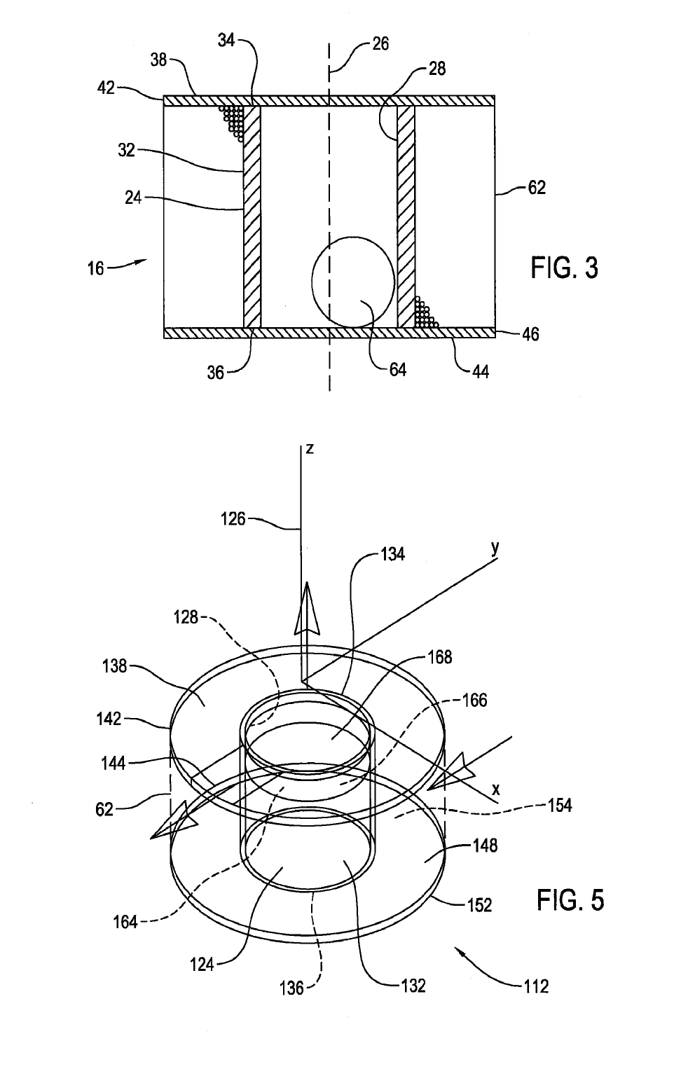

Referring to FIGS. 4, 6 and 7, the first fluid bladder 116 has at least one fluid tight, flexible and resilient film or sheet 178 that surrounds an interior volume of the bladder. In the drawing figures the first fluid bladder sheet 178 is shown as having a generally rectangular block configuration. This is an example only and the bladder sheet could have other configurations and could be formed from two or more sheets. A block shaped piece of open cell foam 182 is contained inside the first bladder interior volume. This block 182 basically supports the first bladder 178 rectangular block configuration. The open cells of the foam 182 do not restrict fluid flow in the bladder interior. In a further embodiment of the apparatus the foam block 182 is eliminated from the bladder 178. One side 184 of the block has a curved or semi-circular configuration. This side 184 of the block is shaped to fit in tight conformance around the side of the generator assembly 112 as shown in FIG. 3. With the side of the block 184 positioned against this side of the generator assembly 112 the bladder sheet 178 extends completely around the open cell foam block 182 and sealingly engages over half of the generator assembly 112. However, the first bladder sheet 178 does not seal over the radial groove 144 in the first annular flange 138. The first portion 174 of the chamber interior volume communicates through groove 144 with the interior volume of the first bladder 116. The fluid flow path can be as simple as allowing the bladder skin to be loose over the flange first half and sealed over the second half, to allow the fluid to flow in the desired direction. The groove works to guarantee that the fluid flows without restriction. In addition to the open cell foam block 182 contained in the sheet 78 of the first bladder 16, the first bladder contains a fluid. The fluid could be a gas or a liquid.

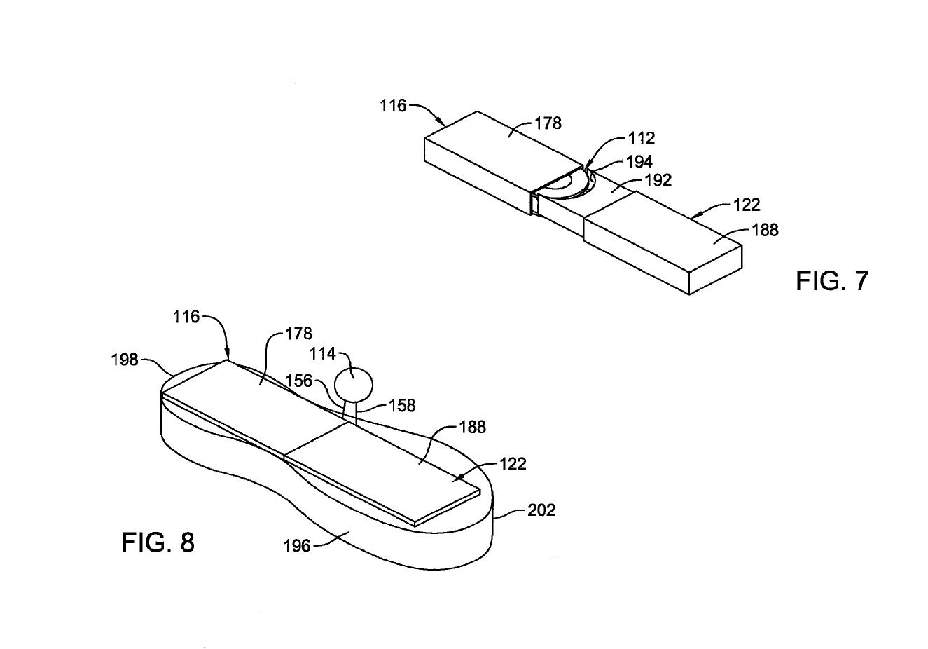

The second fluid bladder 122 is constructed as a mirror image of the first bladder 116. The second bladder 122 also includes at least one fluid tight flexible and resilient film or sheet 88 that surrounds the interior volume of the bladder. In the drawing figures the sheet 188 is shown having the general configuration of a rectangular block. As with the first bladder 16, the second bladder could have a different configuration. An open cell foam block 192 is contained in the interior volume of the second bladder sheet 188. Again however, the foam block 192 could be eliminated from the bladder 122. The open cell foam block 192 also has a curved side 194 that fits against the side of the generator assembly 112 as shown in FIG. 7. In addition to the open cell foam 192, the second bladder sheet 188 also contains a second fluid. The second fluid could be a gas or a liquid. With the second fluid bladder 122 assembled to the generator assembly 112, a portion of the second bladder sheet 188 overlaps and seals over half of the fluid chamber sidewall 124 on the opposite sides of the fluid chamber. The groove 154 in the second annular flange 148 is not sealed closed by the second fluid bladder sheet 188 and the second portion 176 of the fluid chamber interior volume communicates with the interior volume of the second fluid bladder 122 through the groove 154. The fluid flow path can be as simple as allowing the bladder skin to be loose over the flange first half and sealed over the second half, to allow the fluid to flow in the desired direction. The groove works to guarantee that the fluid flows without restriction.

FIGS. 4 and 6-8 illustrate the assembly of the generator assembly 112, the first fluid tight bladder 116 and the second fluid tight bladder 122 in forming the micro-motion generator apparatus of the invention and the positioning of the apparatus in a shoe sole 196. The shoe sole 196 is only one example of an article, such as an article of clothing with which the apparatus may be used.

FIGS. 9 and 10 are schematic representations of the apparatus and its operation in the shoe sole 196. As explained earlier, the first fluid bladder 116 communicates through the groove 144 of the first flange 138 with the first portion 174 of the fluid chamber interior volume, and the second fluid bladder 122 communicates through the groove 154 of the second annular flange 148 with the second portion of the fluid chamber interior volume 176. Compressing the first fluid bladder 116 causes the fluid in the bladder to move through the groove 144 and into the first portion 174 of the fluid chamber interior volume. The fluid entering the first portion of the interior volume 174 forces the magnet 164 to move in a first direction through the chamber interior volume to the chamber sidewall second end edge 136. This movement of the magnet 164 in turn causes fluid to be pushed from the second portion of the interior volume 176 through the groove 154 of the second annular flange 148 and into the second fluid bladder 122. Compressing the second fluid bladder 122 causes the fluid in the bladder to move from the bladder and through the groove 154 and the second annular flange 148 and into the second portion of the chamber interior volume 176. Fluid entering the second portion of the interior volume 176 pushes the magnet 164 in a second direction, opposite the first direction through the chamber interior volume to the first end edge 134 of the chamber sidewall 124. By continuing to alternately compress the first fluid bladder 116 and the second fluid bladder 122 as discussed above, the magnet 164 is reciprocated through the fluid chamber sidewall 124 and the wire coil 162 surrounding the sidewall. The reciprocating movements of the magnet 164 induces a current in the wire coil 162 that is conducted through the wire first 156 and second 158 ends to the load device 114.

When the generator assembly 112, the load device 114, the first bladder 116 and the second bladder 122 are positioned in the shoe sole 196, the bladders will be alternately subjected to compression forces resulting from the movements of a person wearing the shoe. With the first bladder 116 positioned toward the heel 198 of the shoe and the second bladder 122 positioned toward the toe 202 of the shoe, a walking or running stride of a person wearing the shoe will alternately compress the two fluid bladders. The first bladder 116 would be compressed by the person's heel on the initial footfall of a stride, and then subsequently the second bladder 122 would be compressed by the ball of the person's foot with the heel of the person's foot being raised from the first bladder 116 as the person completes the stride. These repeated movements of the person's foot would cause the magnet 164 to reciprocate in the chamber sidewall 124 and induce an electric current in the wire coil 162 that powers the load device 114.

As described above, the micro-motion generator apparatus provides an inexpensively manufactured and efficiently assembled and operated generator assembly that could be provided on an article, such as an article of clothing to power a load device on the article of clothing in response to movements of the person wearing the article of clothing.

As various modifications could be made in the construction of the apparatus herein described and illustrated and its method of use without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

1. A micro-motion generator apparatus comprising:
a generator assembly consisting of a chamber having a sidewall with an interior surface that surrounds an interior volume of the chamber, the sidewall having opposite first and second end edges, first and second end walls secured to the respective first and second end edges of the sidewall sealing closed the interior volume of the chamber, a wire having a length with opposite first and second ends, the wire being wrapped in coils around the chamber sidewall with the first and second ends of the wire extending from the coils and being connectable to an electric load device, and a magnet in the chamber interior volume, the magnet being free to move in reciprocating movements in the chamber interior volume and thereby inducing an electric current in the coils of the length of wire.

2. The apparatus of claim 1, further comprising:
an electric load device connected to the wire first and second ends.

3. The apparatus of claim 1, further comprising:
the magnet being spherical.

4. The apparatus of claim 3, further comprising:
the chamber sidewall being cylindrical with the interior surface having an interior diameter dimension and the magnet having a diameter dimension that is smaller than the cylindrical interior surface interior diameter dimension enabling the magnet to move in rotation around the cylindrical interior surface of the sidewall.

5. The apparatus of claim 2, further comprising:
an object that experiences frequent movements, the generator assembly and the electric load device being on the object whereby the frequent movements of the object result in movements of the magnet in the chamber interior volume inducing an electric current in the coils of the length of wire that powers the electric load device.

6. The apparatus of claim 1, further comprising:
the magnet inside the chamber interior volume separating a first portion of the chamber interior volume on one side of the magnet and a second portion of the chamber interior volume on a second side of the magnet;
a first fluid bladder containing a first fluid, the first fluid bladder being connected to the chamber and communicating the first fluid with the first portion of the chamber interior volume;
a second fluid bladder containing a second fluid, the second fluid bladder being connected to the chamber and communicating the second fluid with the second portion of the chamber interior volume; and,
an object that experiences frequent movements, the chamber with the magnet in the chamber and the length of wire wrapped around the chamber, the first fluid bladder and the second fluid bladder all being on the object whereby the frequent movements of the object result in the alternate movement of the first fluid from the first fluid bladder into the first portion of the chamber interior volume forcing the magnet to move in a first direction through the chamber interior volume increasing the first portion of the chamber interior volume while decreasing the second portion of the chamber interior volume, and movement of the second fluid from the second fluid bladder into the second portion of the chamber interior volume forcing the magnet to move in a second direction through the chamber interior volume, opposite the first direction, increasing the second portion of the chamber interior volume while decreasing the first portion of the chamber interior volume.

7. The apparatus of claim 6, further comprising:
the magnet being a permanent magnet and being the only magnet in the chamber interior volume.

8. The apparatus of claim 6, further comprising:
the chamber interior volume containing only the magnet, the first fluid and the second fluid.

9. The apparatus of claim 6, further comprising:
the chamber being in fluid communication with only the first and second fluid bladders.

10. The apparatus of claim 6, further comprising:
the chamber having a cylindrical interior surface and the magnet having a cylindrical side surface that engages in a sealing, sliding engagement with the chamber interior surface.

11. A micro-motion generator apparatus comprising:
a generator assembly having a chamber with a cylindrical sidewall, the cylindrical sidewall having a cylindrical interior surface that surrounds an interior volume of the chamber, the cylindrical interior surface having a center axis that defines mutually perpendicular axial and radial directions, the sidewall having axially opposite first and second end edges, first and second circular discs closing over the respective first and second end edges of the sidewall and sealing the interior volume of the chamber, a length of wire having opposite first and second ends, the length of wire being wrapped in coils around the chamber sidewall with the first and second ends of the wire extending from the coils, the wire first and second ends being connectable to an electric load device, a spherical magnet in the chamber interior volume, the magnet being free to move in the chamber interior volume in axially reciprocating movements and in rotational movements around the cylindrical interior surface of the chamber sidewall; and,
an electric load device electrically connected to the wire first and second ends.

12. The apparatus of claim 11, further comprising:
an article that is moveable by a person, the generator assembly and the electric load device being on the article whereby movement of the article by a person results in movements of the magnet in the chamber interior volume that induces an electric current in the coils of the length of wire that powers the electric load device.

13. The apparatus of claim 12, further comprising:
the article being an article of clothing.

14. A micro-motion generator apparatus comprising:
a generator assembly having a chamber with a sidewall having a interior surface surrounding an interior volume of the chamber, the sidewall having axially opposite first and second end edges, first and second end walls secured to the respective first and second end edges of the sidewall and securing closed the chamber interior volume, a wire having a length with opposite first and second ends, the wire being wrapped in coils around the chamber sidewall with the first and second wire ends extending from the coils, a magnet in the chamber interior volume with there being no other mechanical component part of the apparatus in the chamber interior volume, the magnet being free to move in reciprocating movements through the chamber interior volume with movements of the magnet inducing an electric current in the coils of the wire; and,
an electronic load device electrically connected to the first and second ends of the length of wire.

15. The apparatus of claim 14, further comprising:
the magnet being spherical.

16. The apparatus of claim 15, further comprising:
the chamber sidewall interior surface having an interior diameter dimension; and,
the magnet having a diameter dimension that is smaller than the chamber sidewall interior surface diameter dimension enabling the magnet to move in rotation around the cylindrical interior surface of the sidewall.

17. The apparatus of claim 14, further comprising:
the sidewall having a cylindrical interior surface with a center axis;
the magnet having a cylindrical surface with a center axis that is coaxial with the sidewall center axis, a first circular surface at a first end of the magnet and a second circular surface at an axially opposite second end of the magnet, the magnet cylindrical surface engaging in a sliding and sealing engagement with the chamber sidewall interior surface for axially reciprocating movements of the magnet through the chamber interior volume between a first position of the magnet where the magnet is adjacent the sidewall first end edge and a second position of the magnet where the magnet is adjacent the sidewall second end edge, the magnet dividing the chamber interior volume into a first portion of the chamber interior volume adjacent the sidewall first end edge and a second portion of the chamber interior volume adjacent the sidewall second end edge;
a compressible and expandable first fluid bladder, the first fluid bladder having at least one fluid tight skin enclosing an interior volume of the first fluid bladder, a first fluid contained in the interior volume of the first fluid bladder, the first fluid bladder being connected in communication with the chamber and communicating the first fluid in the interior volume of the first fluid bladder with the first portion of the chamber interior volume; and,
a compressible and expandable second fluid bladder, the second fluid bladder having at least one fluid tight skin enclosing an interior volume of the second fluid bladder. A second fluid in the interior volume of the second fluid bladder, the second fluid bladder being connected in communication with the chamber and communicating the second fluid with the second portion of the chamber interior volume.

18. The apparatus of claim 17, further comprising:
an article that is wearable by a person, the chamber, the load device, the first fluid bladder and the second fluid bladder all being on the article whereby when the article is worn by a person movement of the article by the person results in movement of the first fluid from the first fluid bladder and into the first portion of the chamber interior volume forcing the magnet to move in a first direction through the chamber interior volume increasing the first portion of the chamber interior volume while decreasing the second portion of the chamber interior volume, and movement of the second fluid from the second fluid bladder and into the second portion of the chamber interior volume forcing the magnet to move in a second direction opposite the first direction, increasing the second portion of the chamber interior volume while decreasing the first portion of the chamber interior volume, and whereby the reciprocating movements of the magnet in the first direction and second direction induce an electric current in the coil of wire that is supplied to the load device.

19. The apparatus of claim 18, further comprising:
the magnet being a permanent magnet and being the only magnet in the chamber interior volume.

20. The apparatus of claim 18, further comprising:
the first fluid bladder being in fluid communication with only the chamber interior volume; and
the second fluid bladder being in communication with only the chamber interior volume.
